(19) United States
(12) Patent Application Publication
(10) Pub. No.: US 2008/0186145 A1
(43) Pub. Date: Aug. 7, 2008

(54) METHOD OF COOPERATION BETWEEN MOBILE AND FIXED RFID READERS

(75) Inventors: Jathan W. Manley, Blain, MN (US); Brian VanVoorst, Minneapolis, MN (US); Robert C. Becker, Eden Prairie, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/671,147

(22) Filed: Feb. 5, 2007

(51) Int. Cl. H04Q 5/22

(52) U.S. Cl. 340/10.4

(57) ABSTRACT

A system for communicating with RFID tags is disclosed. The system includes at least one RFID tag and a mobile RFID reader operable to interrogate the at least one RFID tag. The system also includes a first fixed RFID reader operable to interrogate the at least one RFID tag, the first fixed RFID reader configured to receive a request to interrogate the at least one RFID tag from the mobile RFID reader and configured to interrogate the at least one RFID tag based on the request from the mobile RFID reader. Additionally, the mobile RFID reader is configured to send a request to interrogate the at least one RFID tag to the first fixed RFID reader.

### BACKGROUND

Radio Frequency Identification (RFID) is used in many industries. One such industry in which RFID is very useful is inventory management. Inventory management is used extensively by storage warehouses, transportation companies, and production facilities; and they may rely heavily on RFID systems. RFID enables these companies to control the logistics of their inventory as items are received and distributed from the facility. In addition to inventory management, RFID is also used in hospitals for patient information, in libraries to locate and check out references, and in passports for more detailed identification information.

RFID technology allows information to be retrieved wirelessly from a RFID tag. The two main components of an RFID system are readers and tags. RFID tags are generally attached to an object and hold information regarding the object. RFID readers communicate with tags to retrieve the information contained in the tag. An RFID tag consists of an antenna connected to a small integrated circuit capable of responding via a wireless link to interrogations and includes a memory for storage of information. Usually, the RFID tag stores information and transmits that information to the RFID reader when requested by the reader. Thus, a user can instantly know the information contained in the RFID tag by transmitting a signal to an RFID tag and receiving a response back from the RFID tag. In inventory management settings RFID tags may contain information about when the object arrived at its location, who signed for it, and where it is being sent. RFID tags can be designed to hold any information as desired for the specific application.

RFID tags are either active or passive. Active tags are larger, contain a battery, and can perform more robust communication and processing. Active tags can respond or transmit a signal at any time and have a larger communication distance. In contrast, passive tags contain no battery and are powered from an external source. Passive tags can be smaller than a credit card, and typically hold less information than active tags. Since passive tags have no power source, they have a shorter communication distance. Passive tags obtain the energy needed to transmit responses from the energy contained in the radio signal they receive.

The two types of tags each have a different target application. Active tags, being larger and more costly, are typically used for more expensive items and items that require a larger amount of information. Passive tags are usually used in cost sensitive applications where a reader will be nearby the tag and a small, unobtrusive tag is desired. For example, passive tags are used on retail items, library books, and personal identification cards.

There are also two types of RFID readers, mobile and fixed. Either type of reader can be used with either type of tag. Mobile readers are handheld devices which a user can transport to a remote area to read tags at that location. In contrast, fixed readers are generally permanently mounted to a structure, and can only read tags within range of the reader at its current location.

Each type of reader has advantages and disadvantages. Mobile readers can travel with a user and provide instant access for the user to tags in the vicinity of the user. Mobile readers are typically used by people who must physically interact with the inventory item to which the tag is attached. Due to their dependence on a battery and their practical size restrictions, however, mobile readers have limited range and limited processing power. The limited reception distance of mobile readers adds difficulty to many tasks. For example, it is difficult for a user of a mobile reader to locate a specific item in a very large warehouse, where items are typically separated by distances greater than the range of the mobile reader. The user has to physically travel within range of every single tag until stumbling upon the desired tag. Similarly, when data processing is desired on a large subset of items, a user must travel to the location of each item, and record the data of each item before they can process the data.

On the other hand, fixed readers are connected to line power and have a much larger communication range. Fixed readers are wired to a terminal from where they can request a scan of the RFID tags. Additionally, multiple fixed readers can be networked together to cover even larger areas. Due to their steady power source and computer connection, fixed readers can quickly scan the inventory to locate an item or obtain information from multiple items. Fixed readers, however, can only be used from their host terminal. In a warehouse setting, this requires a user to leave the warehouse, scan for the object and then return to the warehouse every time the object must be scanned. This is impractical when hundreds of objects must be scanned in a single day.

For the reasons stated above, and for other reasons stated below which will become apparent to those skilled in the art upon reading and understanding the present specification, there is a need in the art for a method of improved communication between RFID tags and mobile readers.

### SUMMARY

The above-mentioned problems of current systems are addressed by embodiments of the present invention and will be understood by reading and studying the following specification. The following summary is made by way of example and not by way of limitation. It is merely provided to aid the reader in understanding some of the aspects of the invention. In one embodiment, a system for communicating with RFID tags is disclosed. The system includes at least one RFID tag and a mobile RFID reader operable to interrogate the at least one RFID tag. The system also includes a first fixed RFID reader operable to interrogate the at least one RFID tag, the first fixed RFID reader configured to receive a request to interrogate the at least one RFID tag from the mobile RFID reader and configured to interrogate the at least one RFID tag based on the request from the mobile RFID reader. Additionally, the mobile RFID reader is configured to send a request to interrogate the at least one RFID tag to the first fixed RFID reader.

### BRIEF DESCRIPTION OF THE DRAWINGS

The present invention can be more easily understood and further advantages and uses thereof more readily apparent, when considered in view of the detailed description and the following figures in which:

FIG. 1 is an illustration of one embodiment of a system of RFID communication;

FIG. 2 is an illustration of one embodiment of a method of communicating between a mobile reader, a fixed reader, and a plurality of tags;

FIG. 3 is an illustration of one embodiment of another method of communicating between a mobile reader, a fixed reader, and a plurality of tags;

FIG. 4 is an illustration of one embodiment of yet another method of communicating between a mobile reader, a fixed reader, and a plurality of tags;

FIG. 5 is a flowchart of one embodiment of a method of operation of a mobile reader;

FIG. 6 is a flowchart of one embodiment of a method of operation of a mobile reader;

FIG. 7 is a flowchart of one embodiment of a method of operation of a fixed reader;

FIG. 8 is an illustration of one embodiment of a mobile reader for use in the system of FIG. 1; and

FIG. 9 is an illustration of one embodiment of a fixed reader for use in the system of FIG. 1.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings that form a part hereof, and in which is shown by way of illustration specific illustrative embodiments in which the device may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Many RFID systems are made up of both fixed readers and mobile readers. Fixed readers often have communication coverage over larger, and sometimes the entire RFID area. In contrast, mobile readers are generally used to obtain tag information from tags that are nearby the user. In a system of both fixed and mobile readers, however, users of mobile readers expend time and energy trying to reach tags that the fixed readers can already communicate with. Moreover, typical systems with both mobile and fixed readers add complexity because tags can only transmit and receive on a single channel. The mobile and fixed readers, therefore, must coordinate interrogation of tags to avoid overlapping signals and causing data corruption.

The present methods address the above problems by allowing a user of a mobile reader to more effectively communicate with a tag in an environment with both fixed and mobile readers. In these methods the mobile reader communicates with the fixed readers, and can offload tasks to the fixed readers. One task that the mobile reader offloads includes allowing the mobile reader to request that the fixed readers interrogate tags on behalf of the mobile reader. The fixed readers then interrogate the tags for the mobile reader. After receiving the interrogation request from the fixed readers, the tags respond to either the fixed reader or the mobile reader. If the response is sent to the fixed reader, the fixed reader then forwards the response to the mobile reader. In addition to interrogation, the fixed reader can also perform processing of the tags for the mobile reader. Since communication with the fixed readers has a higher signal to noise ratio than communicating with the tags, the mobile reader saves power by communicating with the fixed readers. The mobile reader also saves power because the fixed reader performs the tag interrogation work. This allows the mobile reader to transmit and receive fewer signals, and thereby consume less battery power. Additionally, the processing power of the mobile reader is effectively increased, because the mobile reader utilizes the additional processing power of the fixed readers. Finally, the effective range of the mobile reader is increased to include all of the tags in the entire fixed reader network.

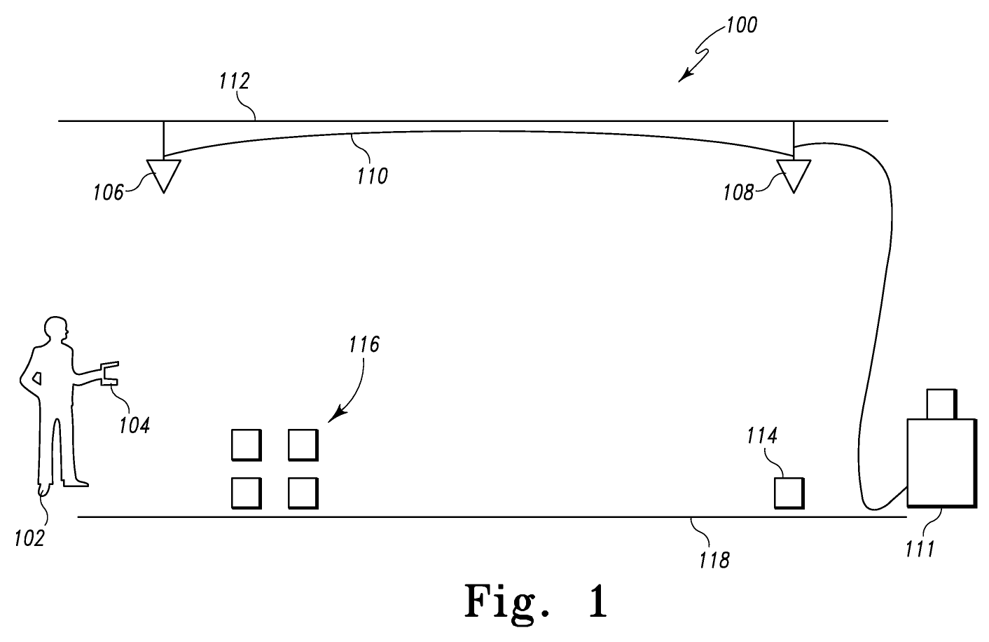

FIG. 1 illustrates one embodiment of an RFID system 100 that allows for efficient communication between a mobile reader and tags. System 100 includes a user 102 holding a hand-held mobile reader 104. Alternatively, mobile reader 104 could be located on a wheeled vehicle, or any other movable apparatus. System 100 also includes fixed readers 106, 108 which are networked together via communication medium 110. In other embodiments, system 100 includes one or more fixed reader(s), e.g., as many readers as required for a particular application. Fixed readers 106, 108 communicate with one another over communication medium 110, and communicate with a terminal 111 from where a user can input requests and receive responses. In system 100, fixed readers 106, 108 are mounted to a ceiling 112 of a warehouse structure. Mobile reader 104 and fixed readers 106, 108 are configured to communicate with RFID tag 114 and a cluster of RFID tags 116 if tag 114 or tags 116 are in range of the respective reader 104, 106, 108. In this description, RFID tag 114 and cluster of RFID tags 116 are referred to collectively as tags 114, 116. In system 100, tags 114, 116 are active tags attached to storage containers placed on a floor 118 of a warehouse structure. Alternatively, in other embodiments, tags 114, 116 are passive tags and are attached to any object or are independent of an object (e.g., a user ID card). In yet other embodiments, the systems includes any appropriate combination of active and passive RFID tags and clusters based on the needs of the application.

Mobile reader 104 and fixed readers 106, 108 communicate with tags 114, 116 by sending and receiving radio frequency signals. The frequency of the radio signal can be any frequency as is known by those skilled in the art. Mobile reader 104 and fixed readers 106, 108 can communicate with any tag that is within transmission and reception range of reader 104, 106, 108. Fixed readers 106, 108 can communicate with tags at larger distances, because fixed readers 106, 108 have a higher signal to noise ratio with tags than mobile reader 104. In system 100, mobile reader 104 is shown to be within range of cluster of tags 116, but tag 114 is out of range. Fixed reader 106 is within range of cluster of tags 116, but is also out of range of tag 114. Fixed reader 108 is within range of tag 114, and out of range of cluster of tags 116.

In addition to communication with tags 114, 116, mobile reader 104 is configured to communicate with fixed readers 106, 108. In system 100, mobile reader 104 communicates with fixed readers 106, 108 on a different channel than tags 114, 116. Instead of directly interrogating cluster of tags 116, mobile reader 104 sends the interrogation to fixed reader 106, which then performs the tag interrogation. Thus, even though cluster of tags 116 are within range of mobile reader 104, mobile reader 104 sends its interrogation request through fixed reader 106 to save battery power in mobile reader 104. Additionally, since fixed reader 106 and mobile reader 104 communicate on a different channel, fixed reader 106 interrogates tags 114, 116, while simultaneously communicating with mobile reader 104. In another embodiment, mobile reader 104 communicates with fixed readers 106, 108 on the same channel as tags 114, 116. In this embodiment, mobile reader 104 and fixed readers 106, 108 coordinate communications so that signals do not overlap and produce corrupted data.

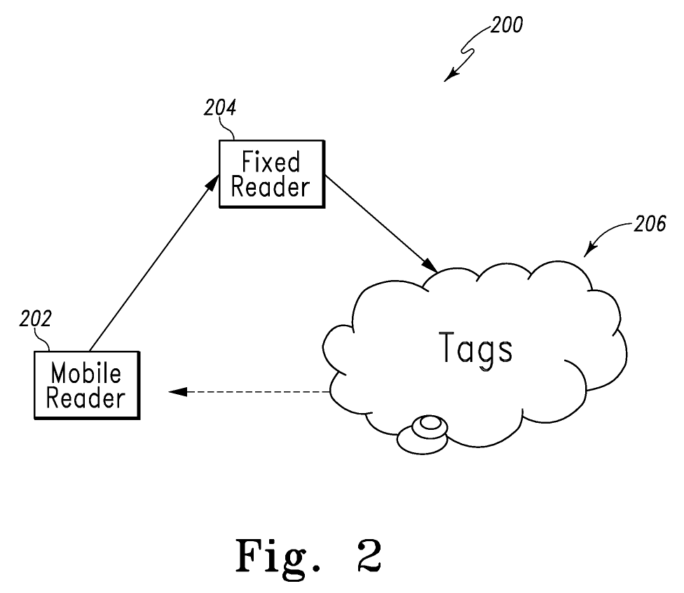

FIGS. 2-4 provide additional detail regarding embodiments of methods of communicating between a mobile reader 202, fixed reader 204 and a plurality of tags 206. In these embodiments, fixed reader 204 is a stand alone reader. Additionally, transmissions to and from plurality of tags 206 refer to transmissions to one or more tags within plurality of tags 206. Mobile reader 202 acts as a master device and gives orders to a slave device, e.g., fixed reader 204. In one embodiment of the methods in FIGS. 2-4, communication with tags 206 is started when a user enters a request into mobile reader 202. Mobile reader 202 receives the request and ascertains whether there is a fixed reader within the communication range of mobile reader 202. In one embodiment, to ascertain whether there are any fixed readers within communication range, mobile reader 202 sends out a ping-like signal and waits for a period of time for a response from a fixed reader. If no response is received, mobile reader 202 determines that there are no fixed readers in range. If there is not a fixed reader within range of mobile reader 202, mobile reader 202 interrogates tags 206 directly. If, however, there is a fixed reader within communication range, e.g. fixed reader 204 as shown in FIGS. 2-4; mobile reader 202 utilizes fixed reader 204 for interrogation of tags 206.

Mobile reader 202 first sends a request to fixed reader 204 for fixed reader 204 to interrogate tags 206 on behalf of mobile reader 202. In one embodiment, the request to interrogate sent by mobile reader 202 is exactly the same as a transmission which mobile reader 202 would send to tags 206. Thus, in this embodiment, fixed reader 204 acts as a bridge and directly forwards the request to tags 206. In another embodiment, the request to interrogate is formatted for communication with fixed reader 204. In this embodiment, fixed reader 204, reads the request, and interrogates tags 206 as described in the request. In yet another embodiment, mobile reader 204 sends a second request for the fixed reader 204 to process the response(s) received from tags 206 and fixed reader 204 responds to mobile reader 202 with only the requested data. In one embodiment, the second request is sent as part of the original request. In an alternative embodiment, the second request is sent separately from original request. More detail will now be provided by referring to FIGS. 2-4.

FIG. 2 illustrates one embodiment of a method 300 of interrogating tags 206. In this embodiment, fixed reader 204 acts a bridge for mobile reader 202. Mobile reader 202 sends a request to fixed reader 204 for fixed reader 204 to interrogate tags 206 on behalf of mobile reader 202. In this embodiment, fixed reader 204 receives the request from mobile reader 202 and interrogates tags 206. By using this method, mobile reader 202 saves power by broadcasting a single time to fixed reader 204 instead of having to interrogate each one of plurality of tags 206 individually. Once the interrogation from mobile reader 202 reaches tags 206, tags 206 respond directly to mobile reader 202 just as if mobile reader 202 had directly interrogated tags 206.

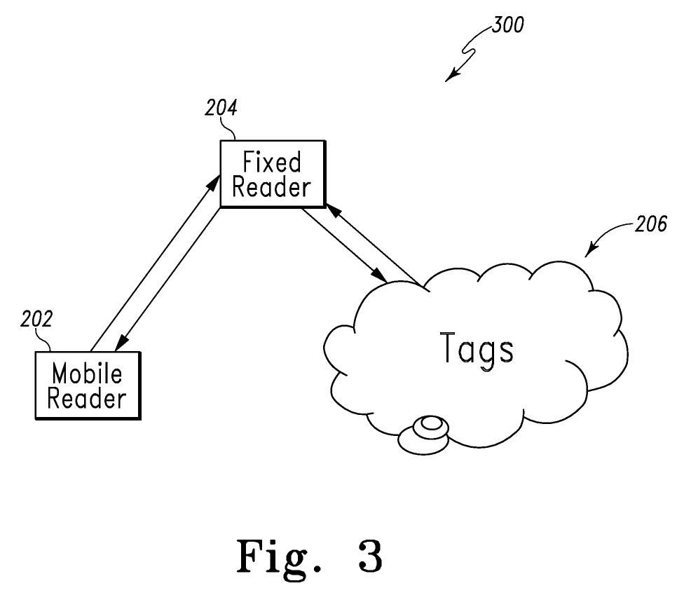

FIG. 3 illustrates one embodiment of another method 300 to communicate with plurality of tags 206. In method 300, all communication to and from tags 206 travels through fixed reader 204. Interrogations from mobile reader 202 are sent to tags 206 in the same manner as in method 200. Responses from tags 206, however, are received by fixed reader 204 and forwarded back to mobile reader 202. Thus, mobile reader 202 saves additional power consumption over method 200 because mobile reader 202 does not have to expend the transmitter power required to communicate with all tags 206. Additionally, mobile reader 202 has effectively extended its range to include the range of fixed reader 204.

In another embodiment of method 300, mobile reader 202 sends a second request for fixed reader 204 to perform data processing for mobile reader 202. Mobile reader 202 sends a request to fixed reader 204 for fixed reader 204 to locate a specific tag or obtain specific information from plurality of tags 206. When fixed reader 204 receives responses back from tags 206, instead of forwarding the responses to mobile reader 202, fixed reader 204 analyzes the responses and obtains the information that mobile reader 202 requested from the responses. In one embodiment, each one of tags 206 respond to the interrogation from fixed reader 204 with a standard response containing all the information of the respective tag. In one embodiment, to analyze these responses fixed reader 206 extracts the data requested by mobile reader 202 from a field in the standard response of each of tags 206. In another embodiment, fixed reader 204 analyses the responses of tags 206 by exchanging several messages with each one of tags 206 to obtain the data requested by mobile reader 202. In yet another embodiment, fixed reader 204 analyzes the responses by sorting through the responses and only forwarding the responses from requested subgroup of tags 206 to mobile reader 202. Fixed reader 204 then forwards the information obtained from the responses to mobile reader 202. This embodiment provides additional processing power to mobile reader 202, by allowing mobile reader 202 to offload not only the communication to and from tags 206, but also processing of the responses from tags 206. In this embodiment, mobile reader 202 will receive only one response from fixed reader 204.

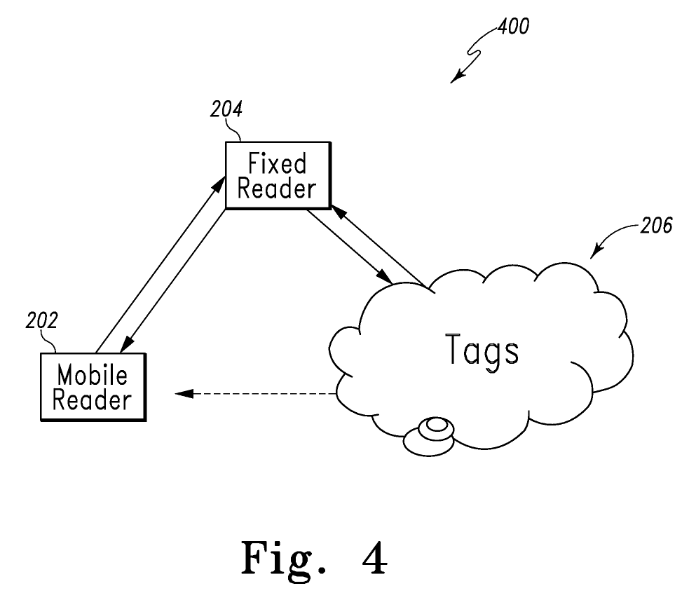

FIG. 4 illustrates one embodiment of yet another method 400 of interrogating a plurality of tags 206. Method 400 is a combination of method 200 and method 300. In method 400, mobile reader 202 interrogates tags 206 by transmitting to fixed reader 204 in the same way as methods 200 and 300. Fixed reader 204 then interrogates tags 206 on behalf of mobile reader 202. Tags 206 respond to the interrogation and at least one of the responses is received by mobile reader 202 and at least one other response is received by fixed reader 204. In one embodiment, fixed reader 204 forwards the response(s) it received to mobile reader 202. Alternatively, fixed reader 204 processes the response(s) and sends the information obtained from the response(s) to mobile reader 202. Mobile reader 202 then combines the data received directly from tags 206 with the data received from fixed reader 204. The combined data is then ready for further processing if requested by the operator of mobile reader 202. In another embodiment, mobile reader 202 communicates with tags 206 directly and the response(s) from tags 206 are received via fixed reader 204. Alternatively, any combination of methods 200, 300, and 400 could be used to communicate to and from tags 206.

In other embodiments of methods 200, 300, and 400, fixed reader 204 is a network of multiple fixed readers 204. FIG. 1 illustrates one embodiment of a network of fixed reader(s) 204 including fixed reader 106 and fixed reader 108 connected by a communication medium 110. As an illustration of method 400 in FIG. 1, mobile reader 104 transmits an interrogation to fixed reader 106. Fixed reader 106 forwards the interrogation to fixed reader 108. Fixed reader 106 interrogates cluster of tags 116. Likewise, fixed reader 108 interrogates tag 114. Mobile reader 104 receives responses from cluster of tags 116. Since the interrogation was forwarded to fixed reader 108, fixed reader 108 knows that mobile reader 104 is likely out of range of tags within reception of fixed reader 108. Fixed reader 108 then receives a response from tag 114 and forwards the response to fixed reader 106. Fixed reader 106 then transmits the response to mobile reader 104. Once mobile reader 104 has obtained all the desired responses, mobile reader 104 combines the responses for further processing if requested.

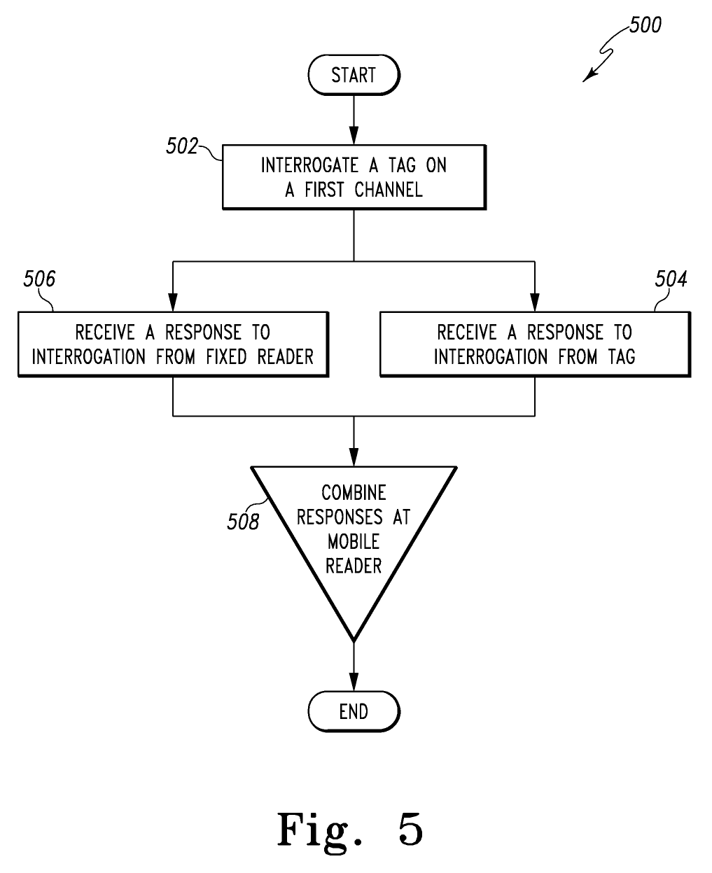

The methods of operating mobile reader 202 and fixed reader 204 will now be explained with reference to FIGS. 5-7. One embodiment of a method 500 of operation of mobile reader 202 is shown in FIG. 5. In this embodiment, mobile reader 202 directly interrogates at least one tag by radio frequency transmission over a first channel (502). In one embodiment, the response based on the interrogation by mobile reader 202 is received directly back from the at least one tag (504). In another embodiment, the at least one tag responds to fixed reader 204 and fixed reader 204 sends the response to mobile reader 202. Thus, the response based on the interrogation by mobile reader 202 is received from fixed reader 204 (506). In yet another embodiment, one response is received directly from the at least one tag and a second response is received from fixed reader 204 regarding at least one other tag. In this embodiment, the responses are combined for further processing, if requested by an operator (508).

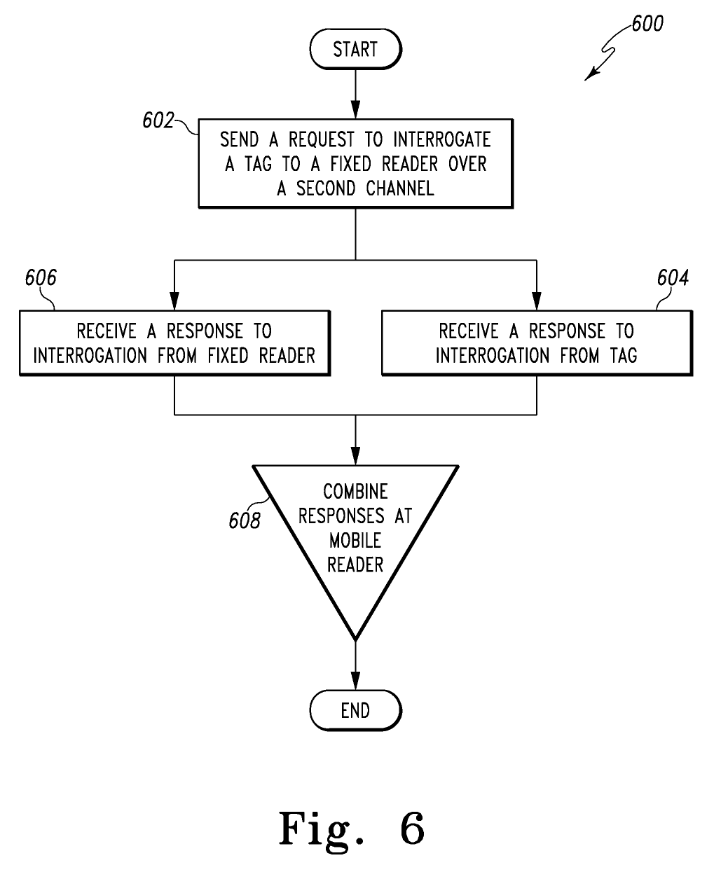

Another embodiment of a method 600 of operation of mobile reader 202 is shown in FIG. 6. In this embodiment, mobile reader 202 sends a request by radio frequency transmission over a second channel to fixed reader 204, requesting fixed reader 204 to interrogate at least one tag on behalf of mobile reader 202 (602). In one embodiment, the response based on the interrogation by fixed reader 204 is received directly back from the at least one tag (604). In another embodiment, the response based on the interrogation by mobile reader 202 is received from fixed reader 204, because the at least one tag responded to fixed reader 202 (606). In yet another embodiment, one response is received directly from the at least one tag and a second response is received from fixed reader 204 regarding at least one other tag. In this embodiment, the responses are combined for further processing, if requested by an operator (608).

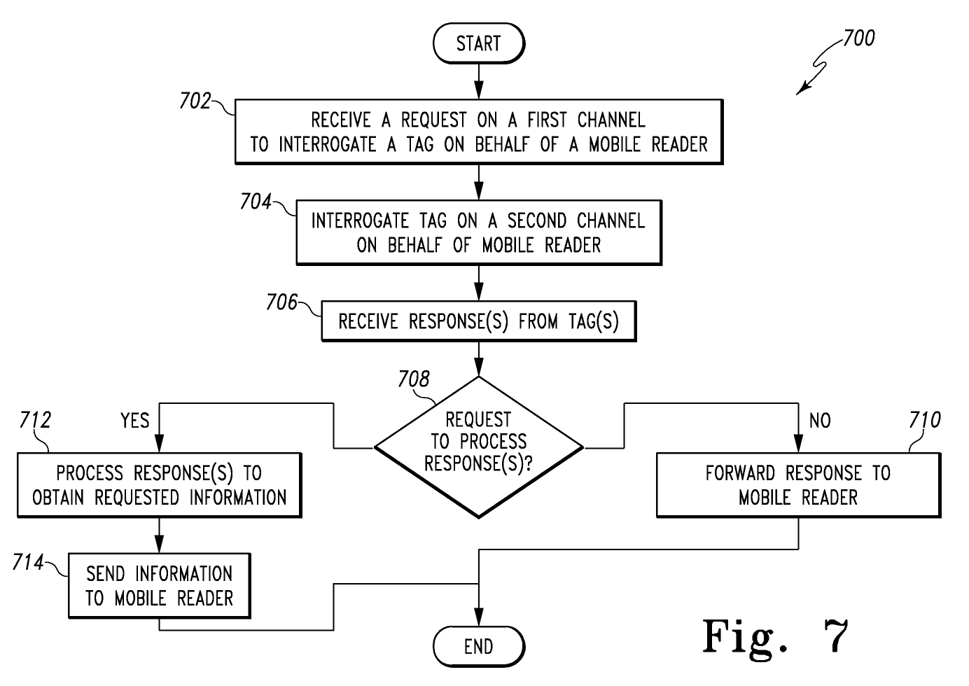

One embodiment of a method 700 of operation of fixed reader 204 is shown in FIG. 7. Fixed reader 204 receives a radio frequency transmission of a request from mobile reader 202 on first channel. The request asks fixed reader 204 to interrogate at least one tag on behalf of mobile reader 202 (702). After receiving the request, fixed reader 204 interrogates the at least one tag as described in the request (704). If the at least one tag is within range of fixed reader 204, fixed reader 204 receives a response for the at least one tag (706). The fixed reader 204, then determines whether it has received a second request from mobile reader 202 for fixed reader 204 to process the response of the at least one tag (708). If fixed reader 204 has not received a second request, fixed reader 204 forwards the response from the at least one tag to mobile reader 202 (710). If fixed reader 204 has received a second request, fixed reader 204 processes the response to obtain the data requested (712). After obtaining the data, fixed reader 204 sends the data to mobile reader 202 (714).

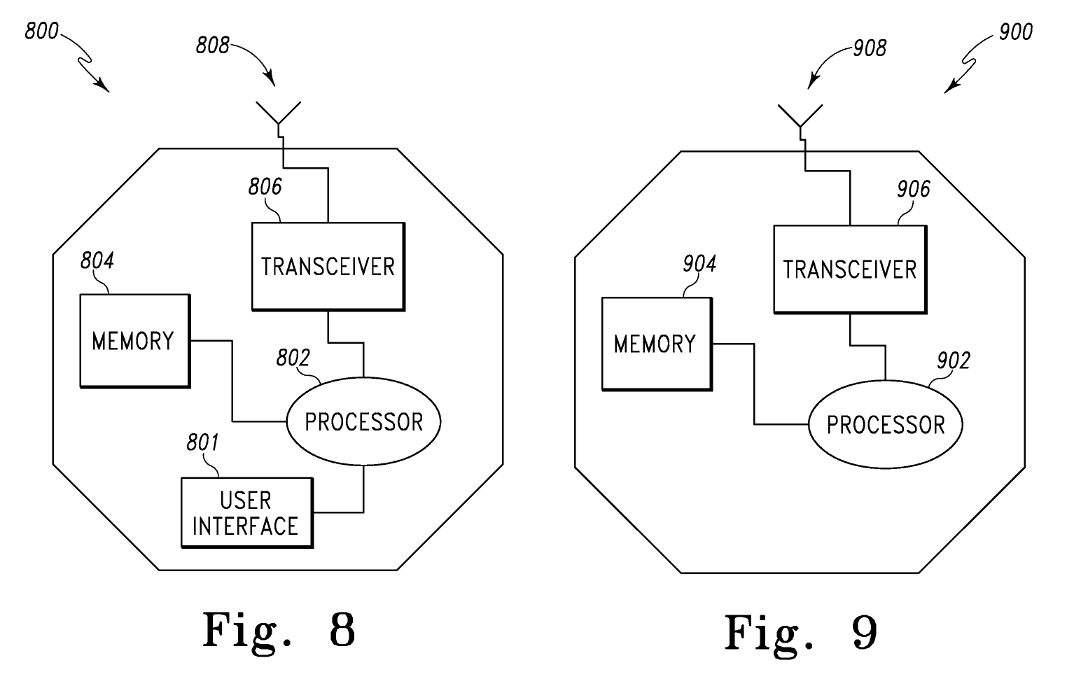

FIG. 8 shows one embodiment of a mobile reader 800 for use with the present methods. Mobile reader 800 has a user interface 801, a processor 802, a memory 804, a transceiver 806, and an antenna 808. A user inputs a request into mobile reader 800 through user interface 801. Processor 802 processes a request received from user interface 801 asking mobile reader 800 to obtain information from a tag. To obtain the information directly from the tag, processor 802 communicates with transceiver 806 to transmit a radio frequency transmission over antenna 808 to the tag. Transceiver 806 sends the interrogation to the tag over a first radio frequency channel. To send a request for a fixed reader to perform the interrogation, processor 802 communicates with transceiver 806 to transmit a radio frequency transmission over antenna 808 to the fixed reader. In one embodiment, transceiver 806 sends the interrogation to the tag over a second radio frequency channel. In this embodiment, transmissions to fixed reader will not interfere with transmissions to the tag. In another embodiment, transceiver 806 sends transmissions to the fixed reader on the same channel as transmissions to the tag. Antenna 808 also receives responses back from the fixed reader and the tag. Transceiver 808 receives the responses and communicates them to processor 802. Processor 802 then obtains the requested information from the response and stores the information in memory 804 for later use.

FIG. 9 shows one embodiment of a fixed reader 900 for use with the present methods. Fixed reader 900 has a processor 902, a memory 904, a transceiver 906, and an antenna 908. Processor 902 processes a request received from a mobile reader to interrogate a tag. To obtain the information from the tag, processor 902 communicates with transceiver 906 to transmit a radio frequency transmission over antenna 908 to the tag. Transceiver 906 sends the interrogation to the tag over a first radio frequency channel. To send a response back to mobile reader, processor 902 communicates with transceiver 906 to transmit a radio frequency transmission over antenna 908 to the fixed reader. In one embodiment, transceiver 906 sends the response to mobile reader over a second radio frequency channel. In this embodiment, transmissions to mobile reader will not interfere with transmissions to the tag. In another embodiment, transceiver 906 communicates to the fixed reader on the same channel as transceiver 906 communicates to the tag. Antenna 908 receives requests from the mobile reader and responses from the tag. Transceiver 908 receives the requests and responses and communicates them to processor 902. Processor 902 then obtains the requested information from the response and stores the information in memory 904 for later use, if needed.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of communicating with an RFID tag at a fixed reader comprising:
receiving a request to interrogate at least one tag on behalf of a mobile reader; and
interrogating the at least one tag on behalf of the mobile reader.

2. The method of claim 1, further comprising:
receiving at least one response from the at least one tag.

3. The method of claim 2, further comprising:
forwarding the response to the mobile reader.

4. The method of claim 2, further comprising:
receiving a second request from the mobile reader to process the at least one response from the at least one tag.

5. The method of claim 4, further comprising:
processing the at least one response; and
sending data obtained from the processing to the mobile reader.

6. The method of claim 1, further comprising:
forwarding the request to interrogate at least one tag to at least one other fixed reader.

7. The method of claim 1, wherein the request is received on a first radio frequency channel and interrogating the at least one tag occurs on a second radio frequency channel.

8. A system for communicating with RFID tags comprising:
at least one RFID tag;
a mobile RFID reader operable to interrogate the at least one RFID tag;
a first fixed RFID reader operable to interrogate the at least one RFID tag, the first fixed RFID reader configured to receive a request to interrogate the at least one RFID tag from the mobile RFID reader and configured to interrogate the at least one RFID tag based on the request from the mobile RFID reader; and
wherein the mobile RFID reader is configured to send a request to interrogate the at least one RFID tag to the first fixed RFID reader.

9. The system of claim 8, further comprising:
a second fixed RFID reader operable to interrogate the at least one RFID tag, the second fixed RFID reader configured to receive a request to interrogate at least one tag from the first fixed RFID reader and configured to interrogate the at least one RFID tag based on the request; and
wherein the first fixed RFID reader is configured to forward a request to interrogate the at least one RFID tag to the second fixed RFID reader.

10. The system of claim 8, wherein the mobile RFID reader further comprises:
a transceiver operable to interrogate the at least one RFID tag on a first channel, and operable to send a request to the first fixed RFID reader on a second channel.

11. The system of claim 8, wherein the fixed RFID reader further comprises:
a transceiver operable to interrogate the at least one RFID tag on a first channel, and operable to send a response to the mobile RFID reader on a second channel.

12. The system of claim 8, wherein the first fixed RFID reader further comprises:
a processor operable to extract data from a response of the at least one RFID tag.

13. A data storage device, characterized in that:
the data storage device contains code which when executed by a processor implements a method of communicating with an RFID tag at a mobile reader comprising:
sending a request to interrogate at least one tag to a fixed reader; and
receiving at least one response to an interrogation based on the request.

14. The data storage device of claim 13, further characterized in that:
the method comprises:
sending a second request to the fixed reader, the second request requesting the fixed reader to process at least one response received at the fixed reader.

15. The data storage device of claim 13, further characterized in that:
the method comprises:
receiving data obtained from the processing from the fixed reader.

16. The data storage device of claim 13, further characterized in that:
the method comprises:
wherein receiving receives the at least one response from the at least one tag.

17. The data storage device of claim 13, further characterized in that:
the method comprises:
wherein receiving, receives the at least one response from the fixed reader.

18. The data storage device of claim 17, further characterized in that:
the method comprises:
receiving at least one other response from at least one other tag; and
combining the at least one response from the fixed reader and the at least one other response from the at least one other tag.

19. The data storage device of claim 13, further characterized in that:
the method comprises:
wherein sending a request, sends a radio frequency transmission.

20. The data storage device of claim 19, further characterized in that:
the method comprises:
wherein sending a request, sends a radio frequency transmission on a first channel; and
interrogating at least one other tag by radio frequency transmission on a second channel.
